(19) United States
(12) Patent Application Publication
(10) Pub. No.: US 2015/0356590 A1
(43) Pub. Date: Dec. 10, 2015

(54) COMMODITY CREDITS FOR SOFTWARE APPLICATION USERS ASSOCIATED WITH SERVICES AND PRODUCTS

(71) Applicants: Rex T. Posadas, Austin, TX (US); Mervyn Pisuena, Round Rock, TX (US); Emmanuel A. Rivera, Austin, TX (US)

(72) Inventors: Rex T. Posadas, Austin, TX (US); Mervyn Pisuena, Round Rock, TX (US); Emmanuel A. Rivera, Austin, TX (US)

(21) Appl. No.: 14/297,553

(22) Filed: Jun. 5, 2014

(51) Int. Cl. G06Q 30/02

(52) U.S. Cl. CPC G06Q 30/0226

(57) ABSTRACT

Methods and systems are described herein related to relating commodity credits with software applications based on users usage of service and products. Users are identified and associated with software applications, such as online games. Users are also associated with services and/or goods used by the users. Credits are provided to the users based on their use/purchase services/goods. The credits are applied to the software applications.

### BACKGROUND

Software applications which include games, productivity, and utility software may be accessed online by users. During initial use or setup, many software applications provide a base configuration to users. In order to progress, acquire different functionality, or achieve different configurations of the software application, a user typically pays additional costs.

For software applications, such as online games, users may be able to progress through different levels by achieving certain goals or to acquire tools to allow them to progress to different/higher levels. Typically, such tools are purchased by the users, are given when the user has reached a particular goal or a set metric by the game, etc. In other software applications, such as utility software, users are able to upgrade the software application by purchasing additional add-on features.

Users often spend a great number of hours to reach goals/metrics of an online game, or make considerable purchases to upgrade a productivity/utility software application. Many users are not predisposed to spend the required hours to advance in a game and/or have the desire to make additional purchases to upgrade a software application.

In many cases, users play not just one game or use not just one software application. Users may be involved in or make use of multiple software applications, such as various online games, utility and software applications. Typical software applications and games provide credits or points that can only be applied to particular software applications and games.

Users are not always predisposed to play games or to use software applications. Users/individuals have other duties and activities to attend to, such as shopping for goods and services, or attending to other activities, such as going to the gym. If a user buys a product or service, the user may be rewarded, but not rewarded as to software applications and/or games.

In certain systems, points/credits may be given or rewarded to users; however, such points/credits tend to be associated with a particular service, provider, or product. Furthermore, such point/credits may be limited in use for a particular service, provider, or product. Therefore, users typically maintain various multiple point and credit systems in order to be able to purchase or exchange for desired services and products.

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is an example scenario that illustrates an overview of facilitating interaction between a platform, various merchants, application providers, and website in regards to providing commodity credits to users, in accordance with the implementations described herein.

FIG. 2 is an example of interactions between merchants, application providers, and websites to a platform as providing commodity credits to users, in accordance with one or more implementations described herein.

FIG. 3 is an example of massive multiplayer online gaming scenario and actions that characters can perform with commodity credits in accordance with one or more implementations described herein.

FIG. 4 is an example of a massive multiplayer online game and actions that can be performed, in accordance with one or more implementations described herein.

FIG. 5 is an example of different mappings applied to actions and commodity credits.

FIG. 6 is a block diagram illustrating an example of platform structure to implement the technology described herein.

FIG. 7 is example process chart illustrating an example method for providing software application commodity credits to users based on the services used by the users,

FIG. 8 is high-level block diagram illustrating an example computer system to implement the technology described herein.

### DETAILED DESCRIPTION

Described herein are architectures, platforms and methods for associating users with software applications, such as online games, with other services and products which may or may not be related to the software application or online games. Commodity credits, which may be considered as points or other types of credits, are earned by users as they purchase or make use of the services and products. Such commodity credits are given to the users and may be applied to various software applications.

In an example implementation, users are identified, associated with software applications and services/products that are used. Commodity credits are provided to the users based on use of such services/products. The users may apply such commodity credits to one or more software applications.

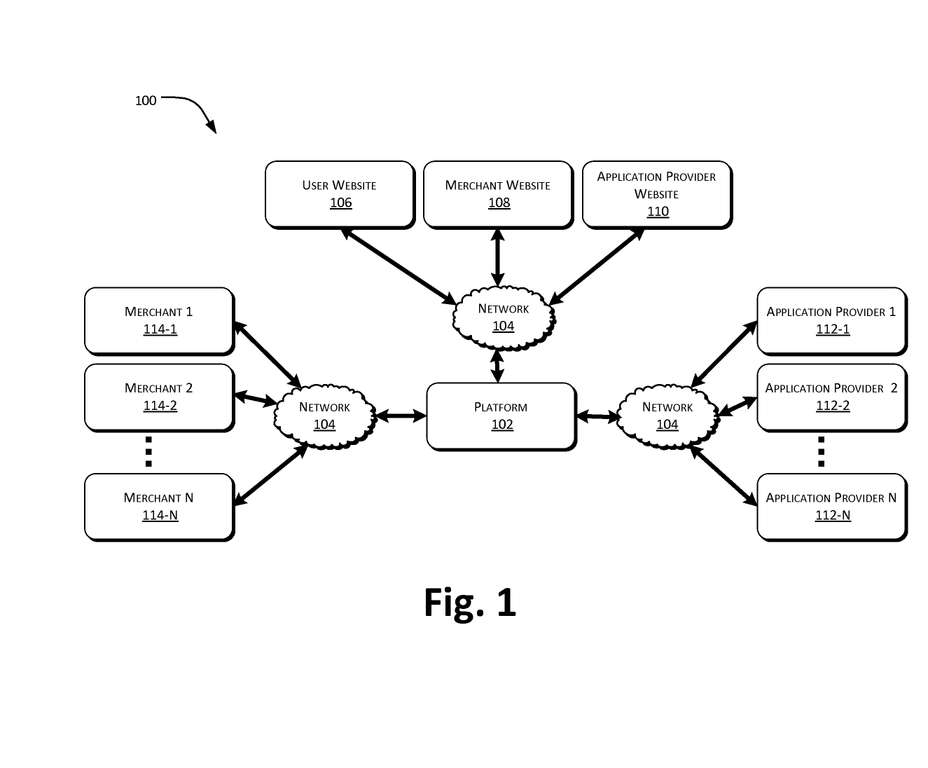

FIG. 1 is an example scenario 100 illustrating an overview of facilitating interaction between a platform, various merchants, application providers, and website in regards to providing commodity credits to users.

The scenario 100 includes a platform 102, which may include software program or code, database(s), etc. Platform 102 may reside in various computing devices, such as servers and such. Furthermore, it is to be understood that platform 102 and the other components described herein may reside in the various computing devices, websites, etc. including and not limited to “cloud” computing and computing devices.

Platform 102 includes, and is not limited to the following described components and functionality. For example, the platform 102 may include various application program interfaces or API(s) that may be exposed and connect to various other platforms and devices, such as servers, computing devices, cloud computing resources, and websites, which in general may be referred to as computing entities.

In this example, the platform 102 is connected to other computing entities through network 104. Network 104 includes various networks and sub-networks, which may be configured as local area networks (LAN), wide area networks (WAN), and wired and/or wireless networks. Furthermore, network 104 may include cloud computing networks and the Internet.

In this embodiment, platform 104 is connected to a user website 106, a merchant website 108, and an application provider website 110. Parties may connect to the platform 104 through their respective websites. In other words, users connect to the platform 104 through user website 106; merchants/service providers connect to the platform 104 through merchant website 108; application providers connect to the platform 104 through user website 110. The websites 106, 108, and 110 may include private and public websites.

In an implementation, the user website 106 allows users for example to view their profile, see their points balance, and buy points with real cash and other forms of payment. As an example, the merchant website 108 may allow merchants to add points to a user's balance, search for transactions and find users participating in the commodity credit system supported by the platform 102. As an example, the application provider website 110, application providers can see a list of users who have used commodity credits for their applications (e.g., games), and see a list of merchants that are participating in the use of the commodity credits. The application provider website 110 may also allow the application providers

It is to be understood, that users may be individuals, groups, or other entities that consume or use services and products, and use software applications such as online games. Merchants may be entities providing services and/or products to users. The services and/or products may or may not be related to software applications used by the users. Application providers may be entities providing software applications such as online games used by users. In addition to online games, software applications may include productivity, utility, and other software applications and programs. In this embodiment, scenario 100 includes one or more application providers 112 and merchants 114.

The platform 102 may be configured to expose application program interfaces or APIs to the public and private websites 106, 108, and 110; expose APIs to the application providers 112; and expose APIs to merchants 114. APIs may be code or components that allow/define other code or components to interact with one another.

In certain embodiments, the platform 102 provides for or includes functionality to convert pre-existing credits or points which are implemented by application providers 112 and/or merchants 114, to commodity credits that may be implemented or used between other application providers 112 and/or merchants 114.

In general, the platform 102 is configured to manage interaction of entities that connect through platform 102 in one or more applications. In other words, platform 102 manages direct/indirect interaction users, application providers 112 and merchants 114. Platform 102 may be implemented using various programming languages, such as “Go” or “golang.” The platform 102 may also implement or make use of various database management languages/tools/systems, such as “MySQL.” As an example, communications between the platform 102 may be implemented using representative state transfer or REST calls. In an implementation, passwords and other sensitive data is encrypted to and from the platform 102.

In certain implementations, a standard currency, credit or point system may be used. For example, a user goes to website 106 to exchange one rewards programs point to another rewards programs point. For example Merchant 1 114-1 points to Merchant 2 114-2 points. Website 106 sends a request to platform 102 to perform the conversion. Platform 102 requests the appropriate points from Merchant 1 114-1. Upon receiving those points, it is converted to standard currency, credit or points. Platform 102 then converts those standard currency, credit or points to an equivalent Merchant 2 114-2 points and sends the credit request to Merchant 2 114-2. After all those requests have succeeded, Platform 102 sends a success message to website 106 letting the user know that the transaction was successful.

In certain implementations, revenue may be generated by exchanging merchant/vendor reward points or credits to a standardized reward point, credit, or currency. Revenue may be generated by charging for use of platform services. For example, a user desires to exchange 1,000 merchant A points for standard currency. According to merchant A, if the user were to use those 1,000 points to fly, it would cost merchant A $100. User goes to the website 106 to do exchange merchant A points to the standard currency. The central platform converts the 1,000 merchant A points to 100 standard currency. It is assumed in this scenario that one (1) standard currency is worth $1 in real US dollars. Once transaction is complete, the user is credited with 100 standard currency points/credits and merchant A is billed for $50 for the transaction. That is half the price of what it would have cost merchant A if the user were to redeem the points in merchant A.

The incentives are as follows. Merchant A saves money since instead of 1,000 points costing them $100, it only costs them $50. The centralized platform generates revenue by billing merchant A for the transaction. The user can use the standard currency to make purchase or upgrade for the software he desires. It may also be the case that user no longer needs merchant A points, leaving unused wasted merchant A points.

For example, user goes to website 106 to exchange points from merchant 1 114-1 to standard currency. When the user requests for the transaction, platform 102 sends a message to merchant 114-1 to begin a transaction for user. The platform 102 also makes a request to deduct points from the users account in merchant 1 114-1. Once that deduction is done, platform 102 adds standard credits for the user. Platform 102 then sends a confirmation message stating that the transaction was complete.

In other implementations, a user wants to redeem standard points for the latest version of game X. User goes to the website and makes the transaction. When the transaction is complete, user receives the latest version of game X. At this point the centralized platform bills game X for an amount agreed upon.

Incentives are as follows. The user benefits because he did not need to spend real money to receive the latest digital content of game X. The game (merchant) benefits because now the user is more invested in playing the game. Player retention is very important for games. Since game X is part of the centralized platform rewards program, the user is more likely to keep playing game X. The centralized platform benefits from billing game X for the transaction.

For example, user goes to website 106 and makes a request to exchange standard points for the latest version of application provider 1 112-1. Platform 102 sends a standard currency to application provider 1 112-1 on behalf of user. Application provider 1 112-1 credits the user with the latest version of the software. Platform 102 debits user account's standard points. User can now download the latest version of application provider 1 112-1.

In other implementations, game X or merchant A does not want to spend resources to build and maintain an online economy and trading system. Merchant A may desire to use the platform 102 for an online economy and trading system. The standard currency then becomes the main currency of the game. For example, game X is a poker game. Players would make bets using the standard currency. In order to do this, game X interacts with the centralized platform 102 API (application program interface) for currency and transactions. Game X may be billed on how much activity is performed against the API per month, etc.

Incentives are as follows. Game saves on human resources, time and upkeep by offloading the creating and maintenance of the economy and trading system to centralized platform. The centralized platform profits by billing game X.

In an example, game 302 does not have the resources to build currency 306 and trade system 310. So, the characters 304 of game 302 uses standard currency 404 from platform 102 in order to buy goods and services in the game. When character 1 304 wants to buy items from character 2 304, character 1 304 will pay with standard currency 404 and character 2 304 will send over the item.

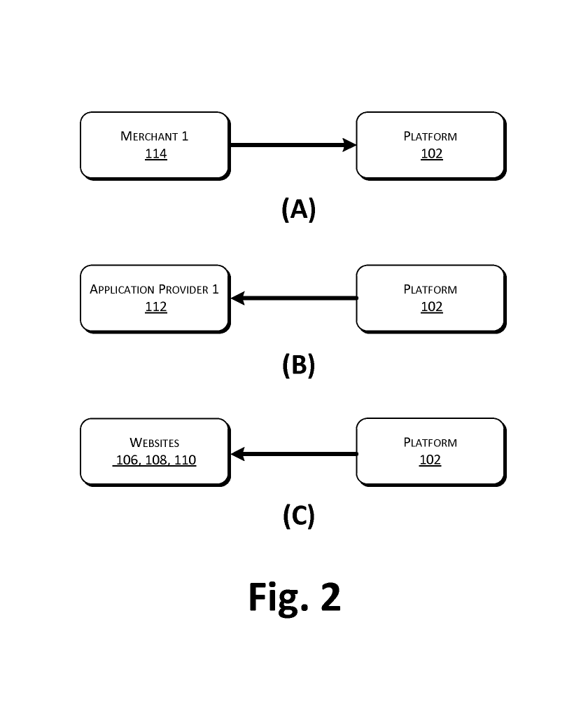

FIG. 2 illustrates interactions that may take place between merchants, application providers, and websites to the platform 102 as providing commodity credits to users, in accordance with one or more implementations described herein.

FIG. 2(A) shows an example interaction between a merchant 114 to the platform 102. In an implementation, the platform 102 provides the ability for merchants 114 add commodity credits (e.g., points) to a particular user's account; convert other credit or point systems to the commodity credit system implemented by platform 102; view user information, application (e.g., game) information, and transaction information that is relevant to the merchant; search particular details relevant for particular transactions which may have specific identifications; and view billing reports. Communication can take place between the merchant 114 and platform 102 using methods and tools that provide real time data updates. Examples of such tools include the use of a representative state transfer or REST calls. As an example, the REST call through an API at the platform 102 communicates and accesses through a Web Service or a file transfer protocol or FTP server managed/controlled by the merchant 114 and pulls data to the platform 114. This implementation of pulling data allows the merchant to secure information that accessed by the platform 102.

FIG. 2(B) shows an example interaction between an application provider 112 and the platform 102. Standard currency may be used to buy in-game items and services. The platform 102 provides a way for games to plugin to a monetary system. This includes a currency for users to buy items, buy services in-game and trade between characters.

In an implementation, the platform 102 provides the ability for application providers 112 to consume commodity credits (e.g., points) for the user; user the commodity credits implemented by platform 102 as the currency the used by the software application (e.g., game); view user information, transactions—in particular, transactions related to the software application (e.g., game), and search particular details relevant for particular transactions which may have specific identifications. Communication can take place between the application provider 112 and platform 102 using methods and tools that provide real time data updates. Examples of such tools include the use of a representative state transfer or REST calls. In particular, a REST call may be implemented to call an API at the platform 102.

FIG. 2(C) shows an example interaction between websites 106, 108 and 110, and the platform 102. In an implementation, the platform 102 provides the ability for websites 106, 108 and 110 to received and display updated information. An API at the platform 102 may be communicated to/accessed by websites 106, 108 and 110. Communication can take place between the application provider 112 and platform 102 using methods and tools that provide real time data updates. Examples of such tools include the use of a representative state transfer or REST calls. In particular, a REST call may be implemented to call an API at the platform 102. Loose coupling to the API from websites 106, 108 and 110 may be used to provide for scaling and code reuse. As discussed above, websites 106, 108 and 110 include public and private websites which may implement use of the API at platform 102. An example of a private website includes User Management System websites implemented for merchants and application providers.

An example implementation as to interaction between the platform 102; the websites 106, 108 and 110; application providers 112; and merchants 114 is as follows. An API resident at the platform 102 may support agreements between merchants and application providers. For example, if a user buys a certain amount of a product from a merchant, the user will receive a commodity credit(s) related to a software application (e.g., game) of the application provider. In another example, if a user utilizes a service by a merchant, such as visiting a “gym” of the merchant, the user in the software application, such as a game, increases his level in the game. In other words, utilization of the service is directly related to the increase in the level of the user in the game, by rewarding the user with appropriate credits. Users are not limited to earning commodity credits by acts related to merchants, and may purchase such commodity credits by using a secured payment system such as “PayPal®” or “CreditCard.” In certain implementations, in order to provide security to users, payment information such as credit cards is not stored by the platform 102. Furthermore, to allow for flexibility, the API is not payment card industry (PCI) compliant. The API may keep a transaction record in the vent that disputes may arise between application providers, merchants and users.

The following example scenario relates to a software application as it relates to online gaming. It is to be understood that the concepts and ideas discussed apply as well to other software applications such as utility and productivity software.

Games types, such as online gaming, include different varieties of games. The concepts discussed related to a commodity credit system may be applied to these different varieties of games. Games may include massive multiplayer online or MMO games. In an MMO game, commodity credits may be used to level up to different characters, trade in a trade systems, and may be used as currency in the game. Games may include first person shooter games. In such first person shooter games, “skins” may be used to buy a weapon (e.g., gun) which may be a different weapon or the latest weapon that is available. More casual games may provide the use of commodity credits to buy different/additional characters. Children's games and games in that generally are “trial ware” may make use of commodity credits to open up different levels of the game. Games having expansion packs may use the commodity credits to purchase or reduce the costs of the expansion packs.

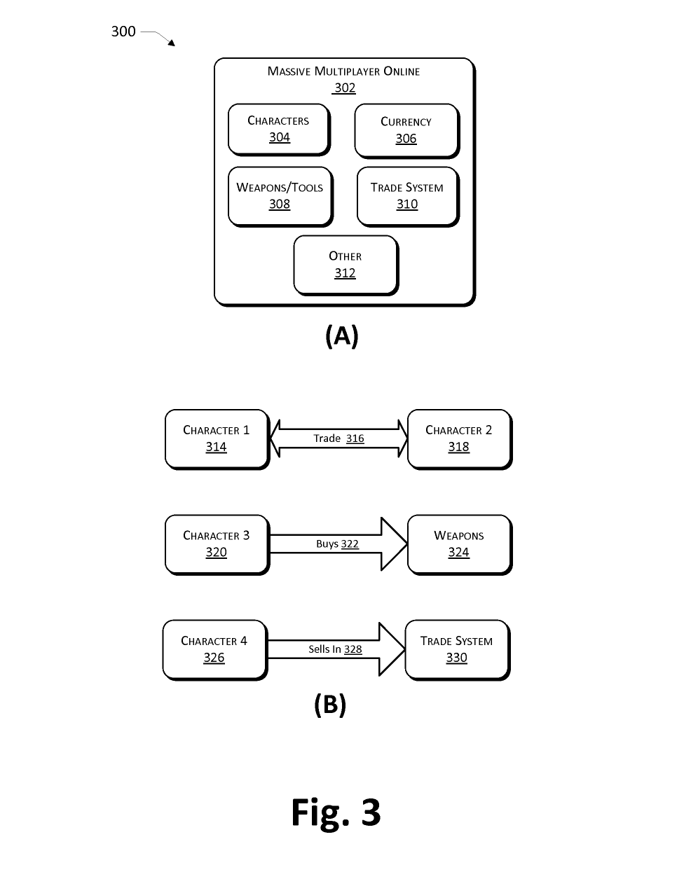

FIG. 3 shows an example of massive multiplayer online (MMO) gaming scenario 300 and actions that characters can perform with commodity credits in accordance with one or more implementations described herein.

FIG. 3(A) shows a block diagram of an example MMO 302. The MMO 302 includes various components such as characters 304 representative of users. The MMO 302 can include currency or currency system 306 used in an exchange system. The currency system 306 may be used to implement the commodity credits described herein. The MMO 302 further may include ways to progress or go on to different higher levels, such as purchasing armour, weapons as represented by weapons/tools 308. Other ways to progress include increase in net worth of characters as reflected in the currency system 306. MMO 302 further may include a trade system 310 allowing characters 304 to trade amongst themselves or with other entities. An example of a trade system 310 includes an auction house where characters may buy and sell goods (e.g., virtual goods). In addition, the MMO 302 may include other components as represented by other 312.

FIG. 3(B) shows example transactions that characters 304 may undertake in a trade system 310. As discussed, characters 304 represent users of the MMO 302. In such transactions or interactions between characters 304 and other components of the MMO 302, commodity credits may be implemented. A “character 1” 314 may perform a trade 316 with another “character 2” 318. In another transaction, a “character 3” 320 buys 322 weapons (also tools, etc.) 324, which may be from other characters 304 or through the trade system 310. In yet another transaction, a “character 4” 326 sells 328 in the trade system 310. In general, a character 304 may perform commerce transactions in the trade system 310, including giving commodity credits to other characters 304.

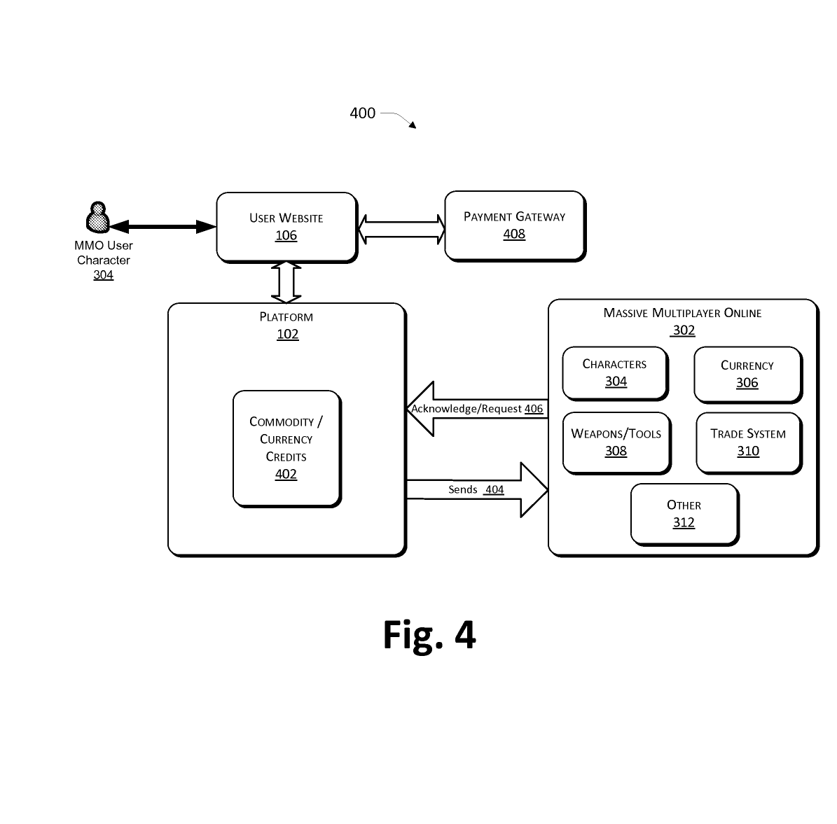

FIG. 4 shows an example scenario 400. An MMO user or character 304 interacts with user website 106. The user website 106 interacts with platform 102, and platform 102 interacts with MMO 302. As an example, MMO user 304 logs in to user website 106, accesses his account and converts a particular currency credit to MMO 302 credits. MMO 302 credits may be a standardized credit or point. The particular currency credit may be specific to a third party provider, merchant, government currency, etc. The currency credit conversion may be performed by commodity/currency credits app module 402. Platform 102 then sends the credits to MMO 302. The action sends 404 may be implemented using web services, file transfer protocol (FTP) or third party interaction standards that MMO 302 supports for sending the MMO credits. For example, there may be various FTP implementations that are used. Such as a FTPS (i.e, FTP over SSL, FTP-ES, FTP secure) that uses certificates, known FTP implementations, SSH File Transfer Protocol (also Secure File Transfer Protocol, or SFTP), and variants of such implementations. Furthermore, for web service instances may use SOAP (Simple Object Access Protocol) messages, which may be implemented by the actions sends 404 and acknowledge/request 406. The action acknowledge/request 406, may be a confirmation message from MMO 302 that the credits were received and applied to MMO user 304.

In further reference to FIG. 4, certain implementations of massive multiplayer online game 302 and actions that can be performed with platform 102. In particular, the MMO 302, and in specific a user (i.e., character 304) of the MMO 302, sends a request 406 to the platform 102. For example, character 304 wants to buy weapons, tools or other accessories, instead of paying using a credit card or service such as Paypal®. Another option may be to use a third party currency. The platform 102 receives the request 406 and may find the user (i.e., character 304) in a database. A determination may be made if the user has enough commodity third party currency credits for the request 410. If there are enough credits, the currency credits are deducted from the user's account. The platform 102 may provide an affirmative response (i.e., provide an “OK”) as to the request 406. The platform 102 then sends 404, which is a payment to MMO 302 system, once the affirmative response is received, the MMO 302 may then add the commodity credits or points to the user's balance in a given game.

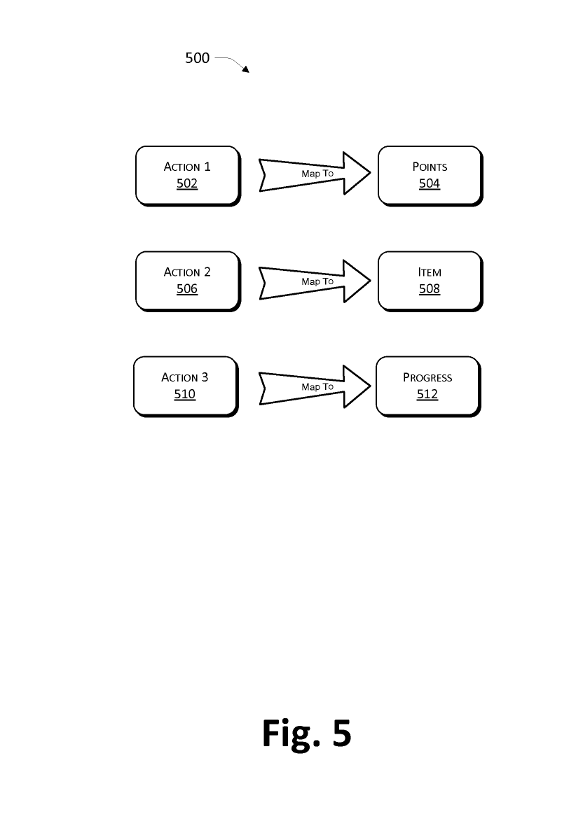

FIG. 5 shows examples of different mappings 500 applied to actions and commodity credits. Commodity credits may be points, access to new/different features of a software application (e.g., game), increase in levels of a character in a game, etc.

For example, an “Action 1” 502 maps to points 504. An example of such a mapping is a user that buys groceries from a merchant and receives points in return for the action of buying groceries. The received points may be used for one or more software applications (e.g., games).

As another example, an “Action 2” 506 maps to item 508. An example of such a mapping is a user that buys groceries from a merchant and receives an item related to a software application. For example, the item may be a weapon or tool that is used for a particular online game.

As yet another example, an “Action 3” 510 maps to progress 510. An example of such a mapping is a user goes to a gym to exercise. By his visit and action to the gym, the user is rewarded with progress in a game. In certain implementations, the “Action 3” 510 directly maps to progress 510 in a particular game. In other words, a user that physically performs an act (e.g., Action 3″ 510) progresses in a game by such an act.

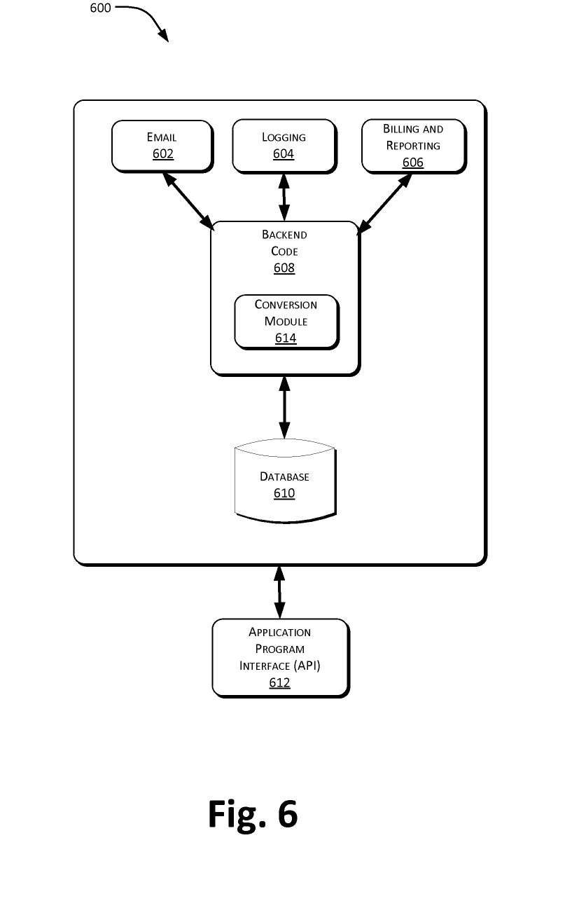

FIG. 6 shows a block diagram illustrating an example of platform structure 600. The platform structure 600 may implement the described platform 102 above. The platform structure 600 may be hosted in various computing devices, such as physical servers. In certain implementations, cloud hosting may be implemented for the platform structure 600. It is to be understood that different hosting systems and combinations of such, may also be implemented.

The platform structure 600 may provide for certain functionality, such as email 602, logging 604, and billing and reporting 606. Backend code 608 may be implemented in a group of servers with a load balancer. The backend code 608 interacts with email 602, logging 604, and billing and reporting 606. The backend code 608 may also include a point conversion module. The point conversion module converts other rewards/points systems to the commodity credit system of platform 102/platform structure 600.

The backend code 608 may connect to one or more databases 610. In certain implementations, the databases 610 will include a cluster of databases that provide particular data and/or redundancy. The databases 610 include the entities that are part of the system, such as users, merchants, games, transactions, etc. The platform structure 600 further provides a public API(s) 612 that is exposed for merchants, user websites and games. In an implementation, the platform structure 600 exposes an application program interface (API) 612 that allows third parties, such as merchants to convert, point/credit systems to a commodity credit system. In certain implementations, a conversion module 614 may be implanted as part of the backend code 608. The conversion module 614 is not exposed to the public, but is considered as a protected internal application that may include code and a database. Conversions performed by the conversion module 614 may be stored in a database, which may or may not be database 610. In certain implementations, the conversions are performed in real time. In other words, the latest updated rates as agreed upon by merchants and other parties are implemented. In particular, cases the merchants may deduct points/credits at their end during conversion.

A standard currency, or a standardized point or credit unit, may be implemented in the described systems and methods. Such a standard currency may be collected, bought and traded by users to purchase and receive real and virtual goods and services, including upgrades to games, hard goods/products, and tangible services. In certain implementations, such a standard currency is not traded for other points/credits of another system; however, other points/credits of another system may be traded for the standard currency or standard point or credit.

Referring now to FIG. 4, in an implementation, user character 304 logs on to website 106 and purchases standard currency. This process takes the user to a payment gateway provider 408. When the purchase is done, user character 304 is sent back to website 106. This completes the purchasing process. Now referring back to FIG. 3, the trading of currency may be implemented as illustrated by character 1 314 trading with character 2 318.

In certain implementations, the standard currency may be purchased with legal tender, such as United States dollars. The standard currency may be also earned as in a loyalty or reward type system. It is contemplated, that in certain implementations, service and goods providers, such as gaming companies may implement the standard currency as their loyalty or reward point or credit unit. Therefore, eliminating the need to develop/create a loyalty or rewards system.

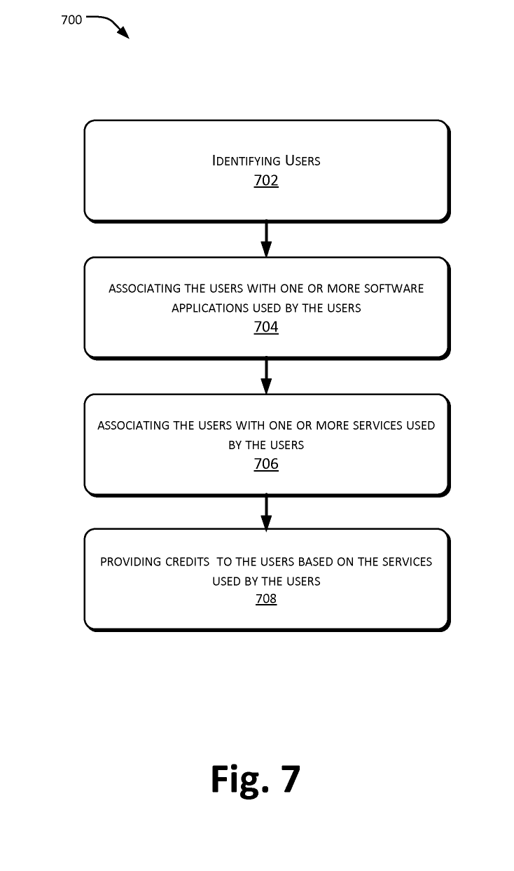

FIG. 7 is example process chart 700 illustrating an example method for providing software application commodity credits to users based on the services used by the users. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 702, users are identified. The users are those individuals and entities that are accessed by or access the platform 102.

At block 704, users are associated with one or more software applications.

At block 706, the users are associated with one or more services used by the users.

At block 708, commodity credits are provided to users based on their use of services/products.

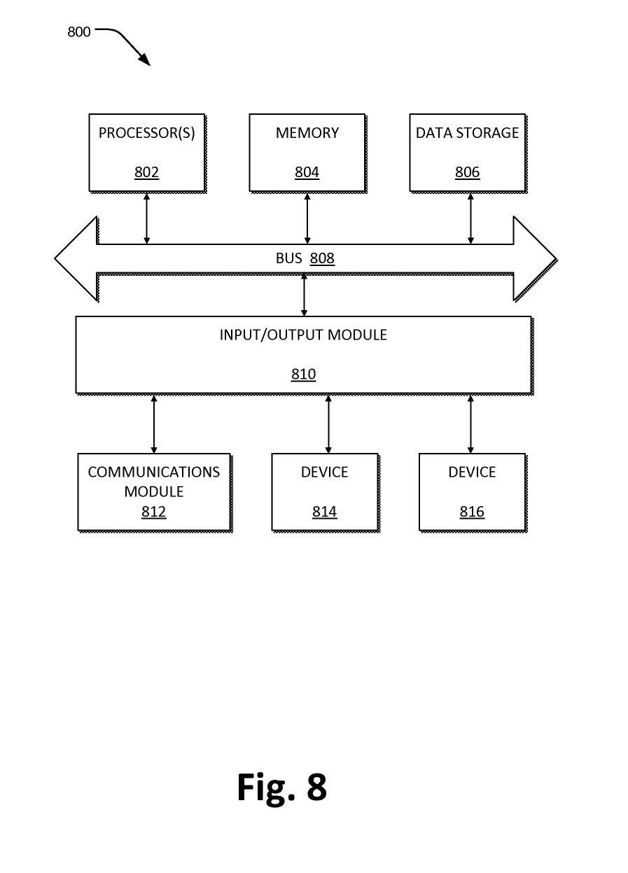

FIG. 8 is a high-level block diagram illustrating an example computer system 800 suitable for implementing the example environment 100 of FIG. 1. In certain aspects, the computer system 800 may be implemented using hardware or a combination of software and hardware.

The illustrated computer system 800 includes one or more processors 802, a memory 804, and data storage 806 coupled to a bus 808 or other communication mechanism for communicating information. An input/output (I/O) module 810 is also coupled to the bus 808. A communications module 812, a device 814, and a device 816 are coupled to the I/O module 810.

The processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The processor 802 may be used for processing information. The processor 802 can be supplemented by, or incorporated in, special purpose logic circuitry.

The memory 804 may be Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device used for storing information, a computer program, and/or instructions to be executed by the processor 802. They memory 804 may store code that creates an execution environment for one or more computer programs used to implement technology described herein.

A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Unless indicated otherwise by the context, a module refers to a component that is hardware, firmware, and/or a combination thereof with software (e.g., a computer program.) A computer program as discussed herein does not necessarily correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The instructions may be implemented in one or more computer program products, i.e., one or more modules of computer program instructions encoded on one or more computer readable media for execution by, or to control the operation of, the computer system 800, and according to any method well known to those of skill in the art. The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

The data storage 806 may be a magnetic disk or optical disk, for example. The data storage 806 may function to store information and instructions to be used by the processor 802 and other components in the computer system 800.

The bus 808 may be any suitable mechanism that allows information to be exchanged between components coupled to the bus 808. For example, the bus 808 may be transmission media such as coaxial cables, copper wire, and fiber optics, optical signals, and the like.

The I/O module 810 can be any input/output module. Example input/output modules 810 include data ports such as Universal Serial Bus (USB) ports.

The communications module 812 may include networking interface cards, such as Ethernet cards and modems.

The device 814 may be an input device. Example devices 814 include a keyboard, a pointing device, a mouse, or a trackball, by which a user can provide input to the computer system 800.

The device 816 may be an output device. Example devices 816 include displays such as cathode ray tubes (CRT) or liquid crystal display (LCD) monitors that display information, such as web pages, for example, to the user.

What is claimed is:

1. A method performed on one or more processors comprising:
identifying users;
associating the users with one or more software applications used by the users;
associating the users with one or more services and/or goods used by the users; and
providing credits to the users based on the services and/or goods used by the users, wherein the credits are applied to the software applications used by the users.

2. The method of claim 1, wherein the software applications are online games.

3. The method of claim 2, wherein the credits allow the users to progress in the online games.

4. The method of claim 2, wherein utilization of a service is directly related to the increase in the level of a user in an online game, by rewarding the user with credits proportionate to the user's use of the service.

5. The method of claim 1, where the credits are standardized as to the software applications.

6. The method of claim 1, wherein the credits are transferable between users.

7. The method of claim 1, wherein the providing credits to the users based on services includes converting previous service credits to credits applied to the software applications.

8. The method of claim 1, wherein a standard credit is used by service and goods providers, and software application providers.

9. The method of claim 1 further comprising converting non standard credits of service and goods providers and software application providers to a standardized credit.

10. A computing device comprising:
one or more processors;
memory coupled to the one or more processors configured to:
identify users and merchants providing services and goods to the users;
associating the users with one or more software applications used by the users;
associating the users with one or more services and/or goods of the merchants used by the users; and
providing credits to the users based on the services and/or goods used by the users, wherein the credits are applied to the software applications used by the users.

11. The computing device of claim 10, wherein the software applications are online games.

12. The computing device of claim 11, wherein the memory is further configured to relate a user's use of a service directly to progress in an online game, by rewarding the user with credits proportionate to the user's use of the service.

13. The computing device of claim 10, wherein the memory is further configured to standardize the credits as to the software applications.

14. The computing device of claim 10, wherein the memory is further configured to transfer credits between users.

15. The computing device of claim 10, wherein the memory is further configured to provide credits to the users based on services by converting previous service credits to credits applied to the software applications.

16. The computing device of claim 10, wherein a standard credit is used by service and goods providers, and software application providers.

17. The computing device of claim 10, wherein the memory is further configured to convert non standard credits of service and goods providers and software application providers to a standardized credit.

18. At least one computer accessible medium having stored thereon a set of instructions that, when executed by one or more processors, direct the one or more processors to execute operations comprising:
identifying users;
associating the users with one or more software applications used by the users;
associating the users with one or more services and/or goods used by the users; and
providing credits to the users based on the services and/or goods used by the users, wherein the credits are applied to the software applications used by the users.

19. The at least one computer accessible medium of claim 18 further comprising:
rewarding a user with credits proportionate to the user's use of a service, wherein utilization of the service is directly related to the increase in level of a user in an online game.

20. The at least one computer accessible medium of claim 18 further comprising:
converting non standard credits of service and goods providers and software application providers to a standardized credit.
